(19) United States
(12) Patent Application Publication
(10) Pub. No.: US 2021/0242953 A1
(43) Pub. Date: Aug. 5, 2021

(54) NETWORK DEVICE, NETWORK SYSTEM, NETWORK METHOD, AND COMPUTER READABLE MEDIUM

(71) Applicant: Mitsubishi Electric Corporation, Tokyo (JP)

(72) Inventors: Kenji KITAYAMA, Tokyo (JP); Ryusuke KAWATE, Tokyo (JP); Jiajia SONG, Tokyo (JP)

(73) Assignee: Mitsubishi Electric Corporation, Tokyo (JP)

(21) Appl. No.: 17/239,876

(22) Filed: Apr. 26, 2021

Related U.S. Application Data
(63) Continuation of application No. PCT/JP2018/047054, filed on Dec. 20, 2018.

(51) Int. Cl. H04J 3/06; H04J 3/08

(52) U.S. Cl. CPC H04J 3/0638; H04J 3/085

(57) ABSTRACT

A network device (100) is included in a ring-type network system (500) which selects a time master. A link processing unit (20) generates a link for communicating a frame. The link processing unit (20) has a frame discarding function of discarding the frame in order to avoid a broadcast storm. A path control unit (108) generates a time distribution path starting at and terminating at a time master, clockwise and counterclockwise of the time master. The path control unit (108) communicates a time synchronization message out of the frame, the synchronization message being used for time synchronization of a plurality of network devices (100). A filtering unit (103), upon acquisition of the time synchronization message, makes the time synchronization message to pass through regardless of the frame discarding function.

### CROSS REFERENCE TO RELATED APPLICATIONS

This application is a Continuation of PCT International Application No. PCT/JP2018/047054, filed on Dec. 20, 2018, which is hereby expressly incorporated by reference into the present application.

### TECHNICAL FIELD

The present invention relates to a network device, a network system, a network method, and a network program.

### BACKGROUND ART

IEEE 1588 defines a method in which, with respect to one or a plurality of time masters, a slave calculates a time difference from the time master at a predetermined timing, and adjusts its own time using the time difference. The time master is also called a grand master. The method of adjusting the time using the time difference from the time master is called Precision Time Protocol (PTP). Further, IEEE 1588 defines an algorithm for selecting a time master on the network, that is, a grand master. This algorithm is called Best Master Clock Algorithm (BMCA).

The BMCA generates a time distribution path starting at a time master and terminating at a slave on a terminal end of a network. The BMCA has a time distribution path for each management area called a domain. The time master puts its own time in a time distribution message and transmits the time distribution message to the network, so as to perform notification for the slave whose time is to be adjusted. The slave acquires time information transmitted from the time master through the time distribution path, calculates the time difference from the time master, and adjusts the time.

Since IEEE 1588 does not define a Layer 2 protocol, it is necessary to adopt the Layer 2 protocol as a lower layer. In general, when employing the Ethernet (registered trademark) standard that is used globally, that is, the IEEE 802.3 standard, the layer 2 protocol to adopt is selected with using judgment criteria such as a network configuration, a number of devices, and reliability or absence of reliability. In the case of a ring topology having a form of a loop, in order to avoid a broadcast storm, a layer 2 protocol is adopted that executes network control such as setting up a device having a closed port and designating a terminal end device when performing transmission.

In addition, dual-ring topology is often adopted to improve reliability. A configuration of the dual-ring topology is a combination of two, clockwise and counterclockwise ring networks, to cope with effectuation of redundancy. According to the configuration of the dual-ring topology, when a failure at one location, that is, a single-location failure such as link disconnection occurs on one route, communication can be recovered by using the other route. A layer 2 protocol compliant with such double-ring topology is defined. Examples mainly include ERP of ITU-T G. 8032 standard, HSR of IEC 62439-3 standard, and RPR of IEEE 802.17 standard. Note that ERP stands for Ethernet (registered trademark) Ring Protection, HSR stands for High availability Seamless Redundancy, and RPR stands for Resilient Packet Ring.

Patent Literature 1 discloses a technique in which a grand master transmits a time synchronization message to both of two communication ports when a failure is detected, thereby guaranteeing arrival of the time synchronization message to an entire network device.

### CITATION LIST

### Patent Literature

Patent Literature 1: JP 2011-139198 A

### SUMMARY OF INVENTION

### Technical Problem

The BMCA defined by IEEE 1588 is utilized to decide a time master of the highest priority on a domain of the network. The time master puts its own time in a time synchronization message and delivers the time synchronization message, to perform notification for a slave whose time is to be adjusted. A time distribution path is a time-information distribution route starting at the time master and extending to the slave. When adopting the conventional layer 2 protocol, the time distribution path depends on a closed port or a load status of the network undesirably. Therefore, in the network system, there is a problem that sometimes an effect of making a time distribution path redundant cannot be obtained.

An objective of the present invention is to form a time distribution path that does not depend on port closure or network load, so as to surely obtain an effect of making a time distribution path redundant in a network system.

### Solution to Problem

A network device according to the present invention is included in a ring-type network system which comprises a plurality of network devices to transmit and receive a frame and which selects a time master serving as a time criterion, from among the plurality of network devices, the network device comprising:

a link processing unit to generate a link for communicating the frame, the link processing unit having a frame discarding function of discarding the frame in order to avoid a broadcast storm; and

a path control unit to generate a time distribution path starting at and terminating at the time master, clockwise and counterclockwise of the time master, the time distribution path communicating a time synchronization message out of the frame, the time synchronization message being used for time synchronization of the plurality of network devices,

wherein the link processing unit comprises a filtering unit which, upon acquisition of the time synchronization message, makes the time synchronization message to pass through regardless of the frame discarding function.

### Advantageous Effects of Invention

In a network device according to the present invention, a path control unit generates a time distribution path starting at and terminating at a time master and communicating a time synchronization message, clockwise and counterclockwise of the time master. When a filtering unit acquires the time synchronization message, the filtering unit makes the time synchronization message to pass through regardless of a frame discarding function. Hence, with the network device according to the present invention, a time distribution path that does not depend on port closure or network load can be formed, so that an effect of making the time distribution path redundant can be reliably provided to each network device.

### BRIEF DESCRIPTION OF DRAWINGS

FIG. 1 is a configuration diagram of a network system according to Embodiment 1.

FIG. 2 is a functional configuration diagram of a network device according to Embodiment 1.

FIG. 3 is a hardware configuration diagram of a network device 100 according to Embodiment 1.

FIG. 4 is a flowchart of a path control unit according to Embodiment 1 in transmission of a BMCA message.

FIG. 5 is a configuration diagram of a transmission correspondence table according to Embodiment 1.

FIG. 6 is a flowchart of the path control unit according to Embodiment 1 in transmission of a PTP message.

FIG. 7 is a flowchart of the path control unit according to Embodiment 1 in transmission of another message.

FIG. 8 is a flowchart of the path control unit according to Embodiment 1 in reception of a message.

FIG. 9 is a configuration diagram of a reception correspondence table according to Embodiment 1.

FIG. 10 illustrates a modification of a hardware configuration of the network device according to Embodiment 1.

FIG. 11 illustrates another modification of the hardware configuration of the network device according to Embodiment 1.

FIG. 12 illustrates a comparative example of a time distribution path constituted by a dual-ring network using an ERP.

FIG. 13 illustrates an example of a time distribution path constituted by the network system according to Embodiment 1.

FIG. 14 is a functional configuration diagram of a network device according to Embodiment 2.

FIG. 15 illustrates an example of a time distribution path constituted on a dual-ring network using HSR.

FIG. 16 illustrates an example of a time distribution path constituted on a dual-ring network using the HSR according to Embodiment 2.

FIG. 17 is a functional configuration diagram of a network device according to Embodiment 3.

FIG. 18 is a configuration diagram of a network system according to Embodiment 4.

FIG. 19 is a configuration diagram of a network system according to Embodiment 5.

FIG. 20 is a functional configuration diagram of a network device according to Embodiment 5.

### DESCRIPTION OF EMBODIMENTS

Embodiments of the present invention will be described with referring to drawings. In the drawings, the same or equivalent portion is denoted by the same reference sign. In description of the embodiments, description of the same or equivalent portion will be appropriately omitted or given only briefly.

### Embodiment 1

***Description of Configurations***

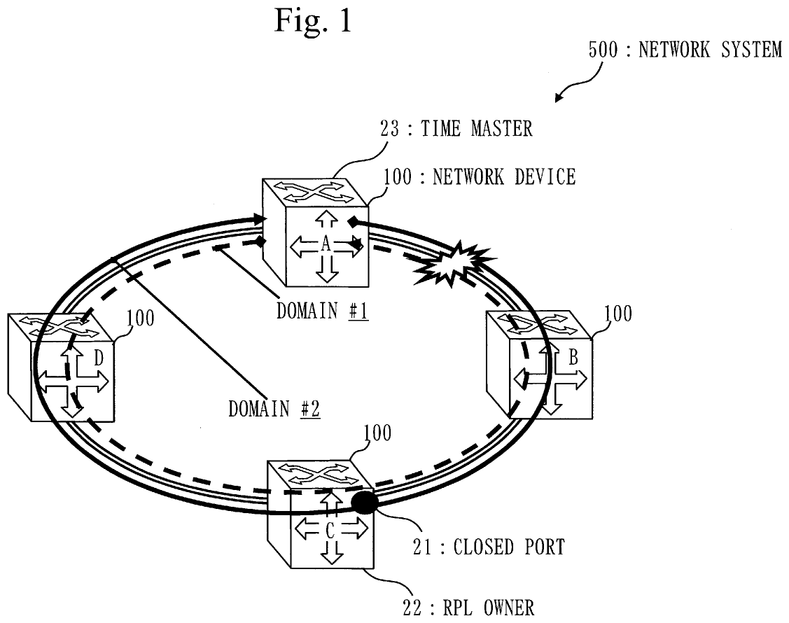

FIG. 1 is a diagram illustrating a configuration of a network system 500 according to the present embodiment.

The network system 500 is provided with a plurality of network devices 100 which transmit and receive a frame. Also, the network system 500 selects a time master 23 serving as a time criterion, from among the plurality of network devices 100. The network system 500 has a ring shape.

The network system 500 is provided with network devices A, B, C, and D as the network devices 100. The network devices A, B, C, and D constitute dual-ring topology. Some network devices among the network devices A, B, C, and D or all of the network devices A, B, C, and D are sometimes called the network device 100 collectively.

The network system 500 is a ring network constructed by an ERP. The ERP enables high-reliability communication by closing a port at one portion of the ring network. The port to be closed will be called a closed port 21. A link route that can be closed by the closed port 21 will be called a Ring Protection Link (RPL). The link route refers to a route that connects a network device to an adjacent network device. The RPL is a link route that connects a network device to an adjacent network device. In FIG. 1, the network device C is an RPL owner 22 having the closed port 21. The network device 100, that is, each of the network devices A, B, C, and D, has a function that implements the ERP.

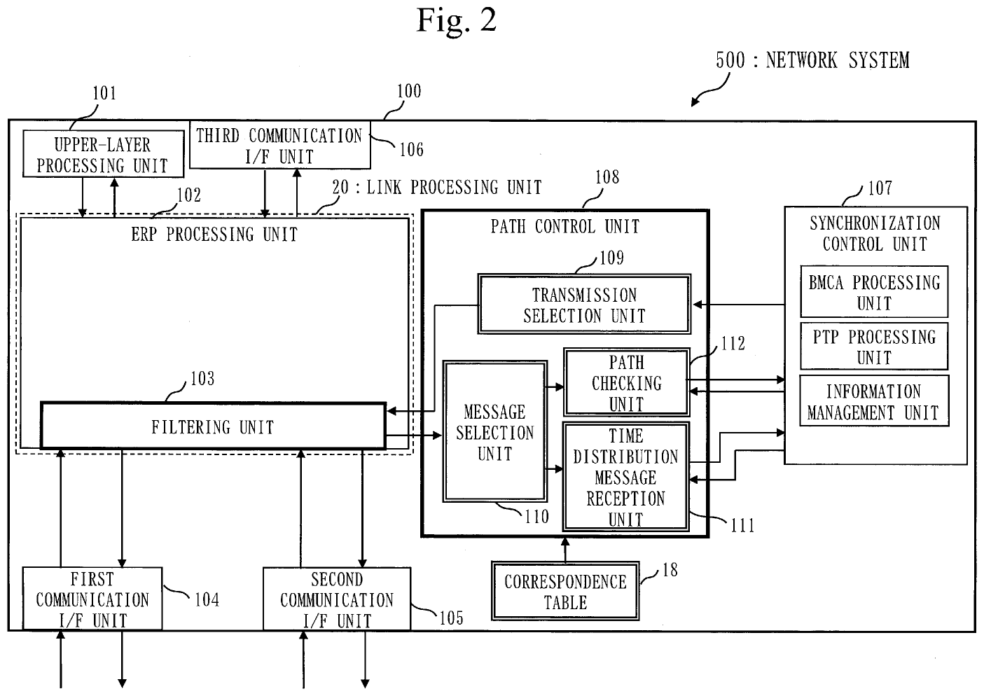

FIG. 2 is a diagram illustrating a functional configuration of the network device 100 according to the present embodiment.

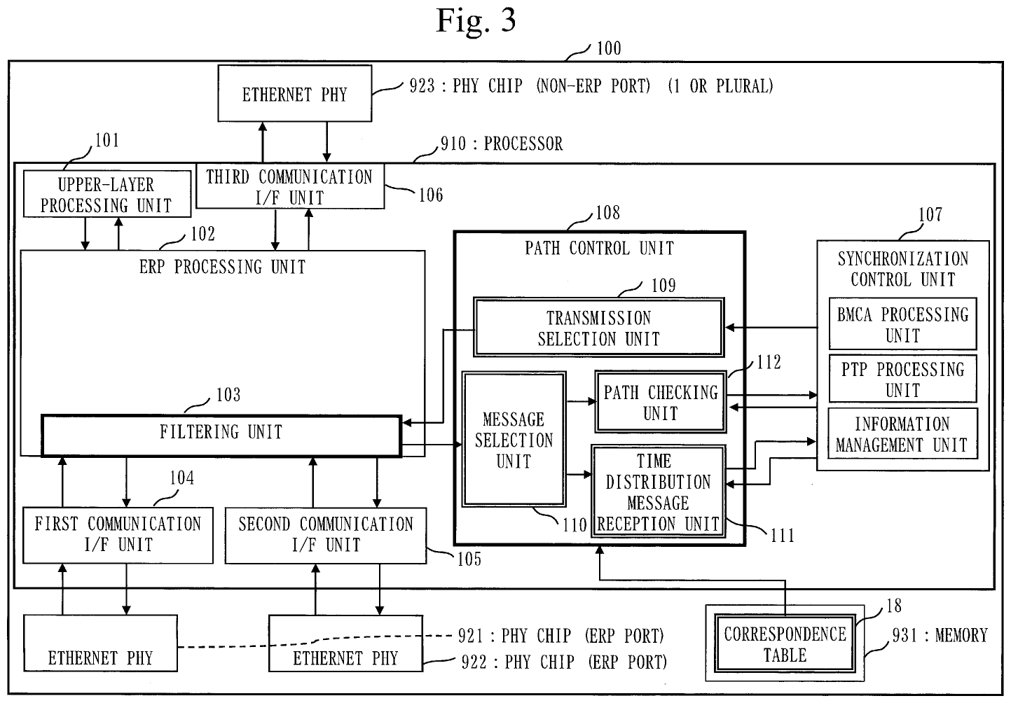

FIG. 3 is a diagram illustrating a hardware configuration of the network device 100 according to the present embodiment.

A configuration of the network device 100 according to the present embodiment will be described with referring to FIGS. 2 and 3.

The network device 100 is a computer.

The network device 100 is provided with an upper-layer processing unit 101, an ERP processing unit 102, a first communication interface unit 104, a second communication interface unit 105, a third communication interface unit 106, a synchronization control unit 107, and a path control unit 108, as function elements. The ERP processing unit 102 is provided with a filtering unit 103. The synchronization control unit 107 is provided with a BMCA processing unit, a PTP processing unit, and an information management unit. The path control unit 108 is provided with a transmission selection unit 109, a message selection unit 110, a time distribution message reception unit 111, and a path checking unit 112.

As illustrated in FIG. 3, the network device 100 is provided with a processor 910, and is also provided with a memory 931. Although not illustrated, the network device 100 is also provided with other hardware devices such as an auxiliary storage device, an input/output interface, and a communication device, in addition to the memory 931. The processor 910 is connected to the other hardware devices via signal lines and controls the other hardware devices.

The processor 910 is a device that executes a network program. The network program is a program that implements functions of the upper-layer processing unit 101, ERP processing unit 102, first communication interface unit 104, second communication interface unit 105, third communication interface unit 106, synchronization control unit 107, and path control unit 108. The upper-layer processing unit 101, the ERP processing unit 102, the first communication interface unit 104, the second communication interface unit 105, the third communication interface unit 106, the synchronization control unit 107, and the path control unit 108 are sometimes individually called units of the network device 100.

The processor 910 is an Integrated Circuit (IC) that performs computation processing. Specific examples of the processor 910 are a Central Processing Unit (CPU), a Digital Signal Processor (DSP), and a Graphics Processing Unit (GPU). Alternatively, the processor 910 may be a Field-Programmable Gate Array (FPGA).

The memory 931 is a storage device that stores data temporarily. Specific examples of the memory 931 are a Static Random-Access Memory (SRAM) and a Dynamic Random-Access Memory (DRAM). A correspondence table 18 is stored in the memory 931.

The auxiliary storage device is a storage device that keeps data. A specific example of the auxiliary storage device is an HDD. The auxiliary storage device may be a portable storage medium such as an SD (registered trademark) memory card, a CF, a NAND flash, a flexible disk, an optical disk, a compact disk, a blu-ray (registered trademark) disk, and a DVD. Note that HDD stands for Hard Disk Drive, SD (registered trademark) stands for Secure Digital, CF stands for CompactFlash (registered trademark), and DVD stands for Digital Versatile Disk.

The input/output interface is a port to be connected to an input/output device such as a mouse, a keyboard, a touch panel, and a display. The display is specifically a Liquid Crystal Display (LCD). The input/output interface is specifically a Universal Serial Bus (USB) terminal or a High-Definition Multimedia Interface (HDMI; registered trademark) terminal. The input/output port may be a port to be connected to a Local Area Network (LAN).

The communication device has a receiver and a transmitter. The communication device is connected to a communication network such as a LAN, the Internet, and the telephone line. The communication device is specifically a communication chip or a Network Interface Card (NIC). In the present embodiment, the network device 100 is provided with Physical layer (PHY) chips 921, 922, and 923, as communication devices. Each of the PHY chips 921, 922, and 923 is an Ethernet (registered trademark) PHY. The PHY chips 921 and 922 are respectively an ERP port connected to the first communication interface unit 104 and an ERP port connected to the second communication interface unit 105. The PHY chip 923 is a non-ERP port connected to the third communication interface unit 106. One PHY chip 923 is provided, or a plurality of PHY chips 923 are provided.

The network program is read by the processor 910 and executed by the processor 910. Not only the network program but also an Operating System (OS) is stored in the memory. The processor 910 executes the network program while executing the OS. The network program and the OS may be stored in the auxiliary storage device. The network program and OS stored in the auxiliary storage device are loaded to the memory and executed by the processor 910. Alternatively, the network program may be built in the OS partly or entirely.

The network device 100 may be provided with a plurality of processors that substitute for the processor 910. The plurality of processors share execution of the network program. Each processor is a device that executes the network program, just as the processor 910 does.

Data, information, signal values, and variable values which are utilized, processed, or outputted by the network program are stored in the memory, the auxiliary storage device, or a register or cache memory in the processor 910.

The term “unit” in the individual unit of the network device 100 may be replaced by “process”, “procedure”, or “stage”. Also, the term “unit” in the individual unit of the network device 100 may be replaced by “program”, “program product”, or “computer readable storage medium storing a program”.

The network program causes the computer to execute each process, procedure, or stage corresponding to the individual unit mentioned above with its term “unit” being replaced by “process”, “procedure”, or “stage”. The network method is a method carried out by the network device 100 executing the network program.

The network program may be stored in a computer readable medium, a recording medium, or a storage medium, and may be provided in the form of the medium. Alternatively, the network program may be provided as a program product.

***Description of Functions***

The upper-layer processing unit 101 acquires information from the ERP processing unit 102 and processes the information in a further upper layer. The upper-layer processing unit 101 also transfers the information processed in the upper layer to the ERP processing unit 102. Note that the upper-layer processing unit 101 may be the third communication interface unit 106 to transfer the information to another network. Alternatively, the upper-layer processing unit 101 may be the first communication interface unit 104 or second communication interface unit 105 to transfer the information to another network device 100.

The ERP processing unit 102 executes a function of an Ethernet (registered trademark) switch, that is, a layer 2 switch, and executes an ERP process. The ERP processing unit 102 has an address learning table inside. The ERP processing unit 102 has a function of performing a transfer process to individual communication ports, a function of failure detection, a function of generating a control frame to be used by the ERP, and a frame multiplexing/separation control function.

The frame multiplexing/separation control function is functionally split among a ring port output processing unit, an upper-layer output processing unit, and a non-ring port output processing unit.

The ring port output processing unit executes transmission arbitration of multiplexing frames inputted from a plurality of communication ports for one output communication port and deciding a frame to output to an Ethernet (registered trademark) ring. The frames inputted from the plurality of communication ports include a frame on an Add traffic which has been transferred from the upper-layer processing unit 101 and a frame on a Transit traffic which has been transferred from the first communication interface unit 104 or the second communication interface unit 105. The upper-layer output processing unit executes transmission arbitration of outputting a frame to an upper-layer processing unit that multiplexes a frame on a Drop traffic which has been transferred from the first communication interface unit 104 or the second communication interface unit 105.

The ERP processing unit 102 is also in charge of controlling the ERP, being a network control protocol using a layer 2. The ERP processing unit 102 also has a protection function and a frame forwarding function. The ERP processing unit 102 generates a control frame to be used in ERP control which is necessary in the above-mentioned protection function, and transfers the control frame to the first communication interface unit 104 or second communication interface unit 105. The protection function includes a failure detection function and a function of avoiding a failure occurrence route by a procedure according to the ERP standard. The frame forwarding function is a function of judging to which port to transfer a frame received with utilizing a Forwarding DataBase (FD), or judging whether to transfer the received frame to the upper-layer processing unit.

The ERP processing unit 102 is an example of a link processing unit 20 that generates a link for communicating a frame. The link processing unit 20 has a frame discarding function of discarding a frame in order to avoid a broadcast storm, as mentioned earlier. In the present embodiment, the link processing unit 20 has, as the frame discarding function, a port closing function of closing a port when a frame is received.

The filtering unit 103, upon acquisition of a time synchronization message out of the frame, makes the time synchronization message to pass through regardless of the frame discarding function. In the present embodiment, the filtering unit 103, upon acquisition of the time synchronization message out of the frame, makes the time synchronization message to pass through regardless of the port closing function. Specifically, the filtering unit 103 has a function of identifying whether the communication port is a closed port, and making the frame to pass through when the frame is a time synchronization message, even if the communication port is a closed port. The filtering unit 103 is also called a closed port pass-through decision filtering unit.

The first communication interface unit 104 corresponds to a first communication port to communicate with another network device. The first communication interface unit 104 is functionally split between a reception processing unit and a transmission processing unit.

First, the reception processing unit identifies a received frame and checks whether the received frame is valid or invalid. If having received a fraudulent preamble, or an error signal from a PHY, the reception processing unit identifies the received frame as being invalid, and notifies a later stage of this fact or discards the received frame. The reception processing unit also extracts information for searching the FDB out of the received frame, and selects a communication port to which to transfer the extracted information. The communication port to which to transfer the extracted information includes the upper-layer processing unit 101, the third communication interface unit 106 being a communication port interface of a non-ring port, and the second communication interface unit 105.

Then, the transmission processing unit passes the frame transferred from the ERP processing unit 102, to the Ethernet (registered trademark) PHY.

The second communication interface unit 105 corresponds to a second communication port which communicates with another network device. The second communication interface unit 105 has the same function as the first communication interface unit 104. Note that communication port to be select is the upper-layer processing unit 101, the third communication interface unit 106, or the first communication interface unit 104.

The third communication interface unit 106 corresponds to a third communication port which communicates with a network other than the network system 500. The third communication interface unit 106 is not a ring port in ERP control, but is a communication port to be connected to another network, that is, a communication port interface of a non-ring port. The third communication interface unit 106 also has the same function as that of the first communication interface unit 104 and that of the second communication interface unit 105. There may be one third communication interface unit 106 or a plurality of third communication interface units 106.

The synchronization control unit 107 has a function of a time synchronization control protocol such as IEEE 1588 and a derivative standard. The synchronization control unit 107 is provided with a BMCA processing unit, a PTP processing unit, and an information management unit. The information management unit keeps preset information for executing time synchronization and information to be used for various control operations.

The path control unit 108 generates a time distribution path starting at and terminating at a time master. The time distribution path communicates a time synchronization message used for time synchronization of a plurality of network devices, out of a frame. The path control unit 108 generates the time distribution path clockwise and counterclockwise of the time master. The time master terminates the time synchronization message.

The path control unit 108 delivers time synchronization message passed from the synchronization control unit 107 to either the first communication interface unit 104 or the second communication interface unit 105 in accordance with a value of a domain. The time synchronization message is used for time synchronization of the plurality of network devices 100. The time synchronization message includes a PTP message and a BMCA message. The PTP message is an example of a time distribution message that contains a time criterion coming from the time master. The BMCA message is a message for selecting the time master. The BMCA message is an example of a path generation message for generating the time distribution path.

Also, the time synchronization message contains control information such as domain information indicating a domain. A domain is set in units of time distribution paths and is defined by IEEE 1588. Time synchronization is executed in units of domains. The path control unit 108 passes the delivered time synchronization message to the filtering unit 103.

The path control unit 108 also identifies the time synchronization message passed from the filtering unit 103. The path control unit 108 identifies whether the time synchronization message is a PTP message or a BMCA message. If the time synchronization message is a BMCA message, the path control unit 108 checks whether a clockwise time distribution path and a counterclockwise time distribution path are generated, and transfers the time synchronization message to the synchronization control unit 107.

The transmission selection unit 109 acquires information including information indicating which domain each communication port corresponds to, from the synchronization control unit 107. Then, the transmission selection unit 109 passes the time synchronization message passed from the synchronization control unit 107, to the filtering unit 103 together with the information indicating to which communication port to output the time synchronization message.

The message selection unit 110 identifies whether the time synchronization message passed from the filtering unit 103 is a PTP message or a BMCA message. Then, the message selection unit 110 delivers the time synchronization message to either the time distribution message reception unit 111 on a later stage or the path checking unit 112.

The time distribution message reception unit 111 transfers the PTP message passed from the message selection unit 110 to the synchronization control unit 107. The time distribution message reception unit 111 checks whether the domain of the PTP message is associated with a communication port via which the PTP message has been received.

The path checking unit 112 checks, based on the BMCA message passed from the message selection unit 110, whether the domain of the BMCA message is a domain associated with a communication port via which the BMCA message has been received. Furthermore, the path checking unit 112 keeps a value of StepsRemoved. The path checking unit 112 decides whether or not its own network device 100 is a time master. Specifically, the path checking unit 112 decides whether or not the own network device 100 is a time master, based on information from the synchronization control unit 107. If it is decided that the own network device 100 is a time mater, the path checking unit 112 compares a value of StepsRemoved received by the first communication interface unit 104 and a value of StepsRemoved received by the second communication interface unit 105, and checks appropriateness of the clockwise or counterclockwise time distribution path.

An example of the above checking method is a method of statically setting a number of devices on the network in advance. Alternatively, the number of devices may be grasped by a function of dynamically grasping network topology, and a value of the grasped number may be compared with a value of StepsRemoved.

***Description of Operations***

Operations of the network device 100 according to the present embodiment will now be described.

In the network device 100, the memory 931 is provided with the correspondence table 18 in which each of the first communication port and the second communication port is associated with each of a domain corresponding to a clockwise time distribution path and a domain corresponding to a counterclockwise time distribution path. The path control unit 108 sends a time synchronization message to a communication port corresponding to a domain which the time synchronization message belongs to, based on the correspondence table 18. The correspondence table 18 has a transmission correspondence table 181 used when transmitting a time synchronization table, and a reception correspondence table 182 used when a time synchronization message is received.

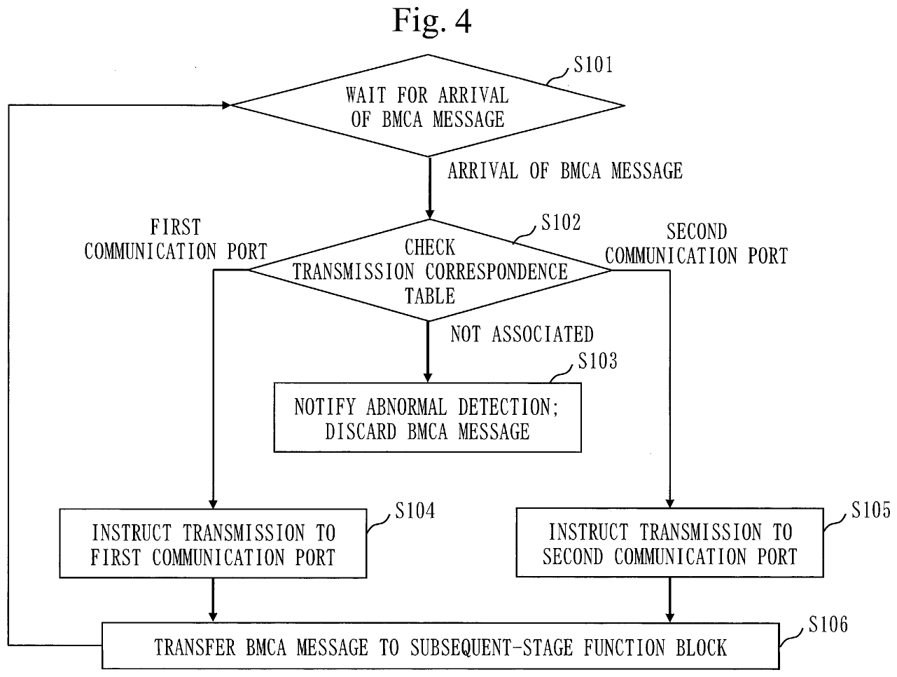

First, operations of the path control unit 108 according to the present embodiment in transmission of a BMCA message will be described with referring to FIG. 4.

In step S101, the transmission selection unit 109 waits for arrival of the BMCA message from the synchronization control unit 107. Upon reception of the BMCA message, the transmission selection unit 109 proceeds to step S102. The BMCA message contains domain information and communication port information, as control information.

In step S102, the transmission selection unit 109 decides to which communication port to transmit the BMGC message, based on the transmission correspondence table 181.

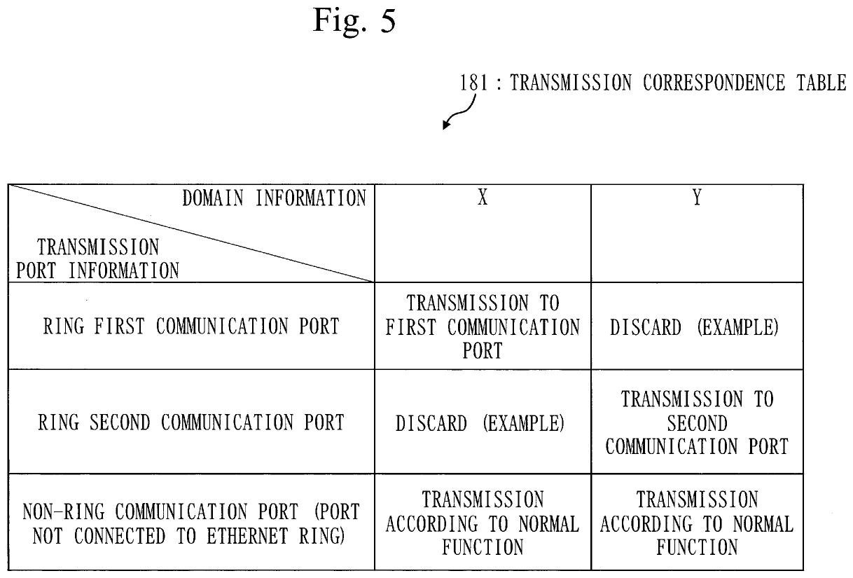

FIG. 5 is a diagram illustrating a configuration of the transmission correspondence table 181 according to the present embodiment.

In the transmission correspondence table 181, the domain information and the transmission port information are associated with each other.

When, for example, the transmission port information in the BMCA message is a ring first communication port and the domain information in the BMCA message is X, the BMCA message will be transmitted to the first communication port. When, for example, the transmission port information in the BMCA message is a ring second communication port and the domain information in the BMCA message is X, the BMCA message will be discarded. When, for example, the transmission port information in the BMCA message is a non-ring third communication port, the BMCA message will be transmitted according to a normal function. That is, when the transmission port information in the BMCA message is a non-ring third communication port and a port of the network device 100 is a closed port, the BMCA message will be discarded.

In this manner, the BMCA message is transmitted in accordance with the transmission correspondence table 181. By performing transmission in this manner, a clockwise time distribution path and a counterclockwise time distribution path that start at the time master are generated. After the generation, a PTP message is transferred sequentially along the paths.

If having decided in step S102 that a communication port to which to transmit the BMCA message is not associated (for example, discard), the transmission selection unit 109 notifies abnormal detection and discards the BMCA message (step S103). If having decided that the communication port to which to transmit the BMCA message is the first communication port, the transmission selection unit 109 outputs a transmission instruction for transmitting the BMCA message to the first communication port (step S104). If having decided that the communication port to which to transmit the BMCA message is the second communication port, the transmission selection unit 109 outputs a transmission instruction for transmitting the BMCA message to the second communication port (step S105).

In step S106, the transmission selection unit 109 transmits the BMCA message to the subsequent-stage filtering unit 103 together with the above transmission instruction.

After that, the filtering unit 103 makes the BMCA message to pass through even when the transmission destination is a closed port.

Hence, the BMCA is sent for the dual-ring network only to one ring or the other (clockwise or counterclockwise). As each network device 100 transmits the MBCA message only to either clockwise or counterclockwise port in each domain, a clockwise time distribution path and a counterclockwise time distribution path are formed.

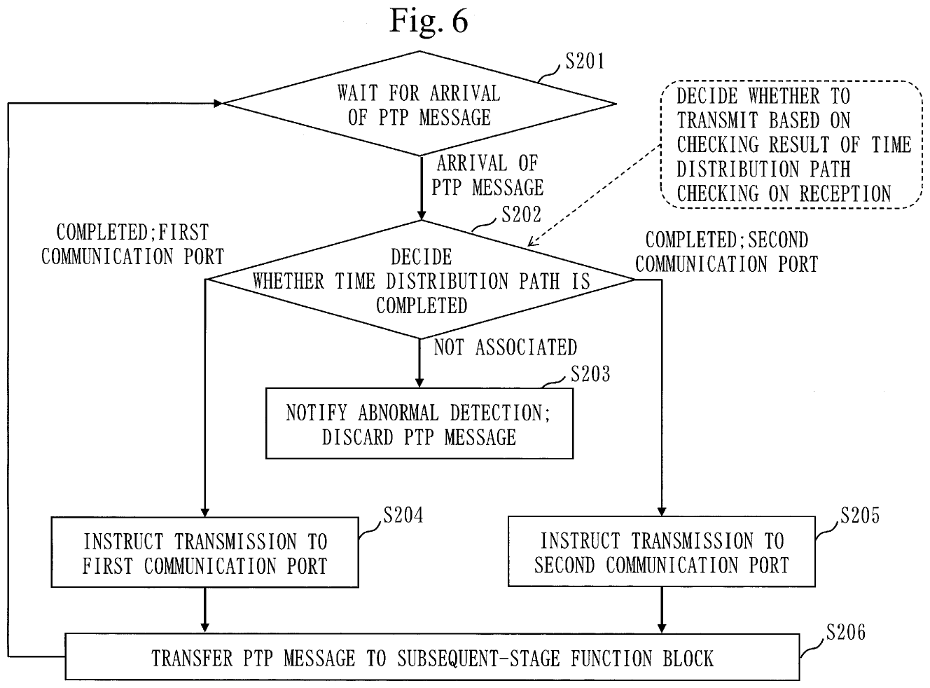

Operations of the path control unit 108 according to the present embodiment in transmission of the PTP message will now be described with referring to FIG. 6.

Having acquired a time distribution message containing a time criterion, that is, a PTP message, out of a time synchronization message, the transmission selection unit 109 of the path control unit 108 decides whether or not a time distribution path is completed. If having decided that a time distribution path is completed, the transmission selection unit 109 sends a time distribution message to the link processing unit 20.

In step S201, the transmission selection unit 109 waits for arrival of the PTP message from the synchronization control unit 107. Upon reception of the PTP message, the transmission selection unit 109 proceeds to step S202.

In step S202, the transmission selection unit 109 decides whether or not a time distribution path is completed. Specifically, the transmission selection unit 109 decides whether or not a time distribution path is completed, using a checking result of the path checking unit 112. The path checking unit 112 has a function of checking appropriateness of the time distribution path when the BMCA message is received.

In step S202, if having decided that a time distribution path is not completed, the transmission selection unit 109 notifies abnormal detection and discards the PTP message (step S203). If having decided that a time distribution path is completed and that the communication port to which to transmit the PTP message is the first communication port, the transmission selection unit 109 outputs a transmission instruction for transmitting the PTP message to the first communication port (step S204). If having decided that a time distribution path is completed and that the communication port to which to transmit the PTP message is the second communication port, the transmission selection unit 109 outputs a transmission instruction for transmitting the PTP message to the second communication port (step S205). Note that the transmission selection unit 109 decides to which communication port to transmit the PTP message, based on the transmission correspondence table 181, and the domain information and communication port information of the PTP message.

In step S206, the transmission selection unit 109 transmits the PTP message to the subsequent-stage filtering unit 103 together with the transmission instruction. After that, the filtering unit 103 makes the PTT message to pass through even when the transmission destination is a closed port.

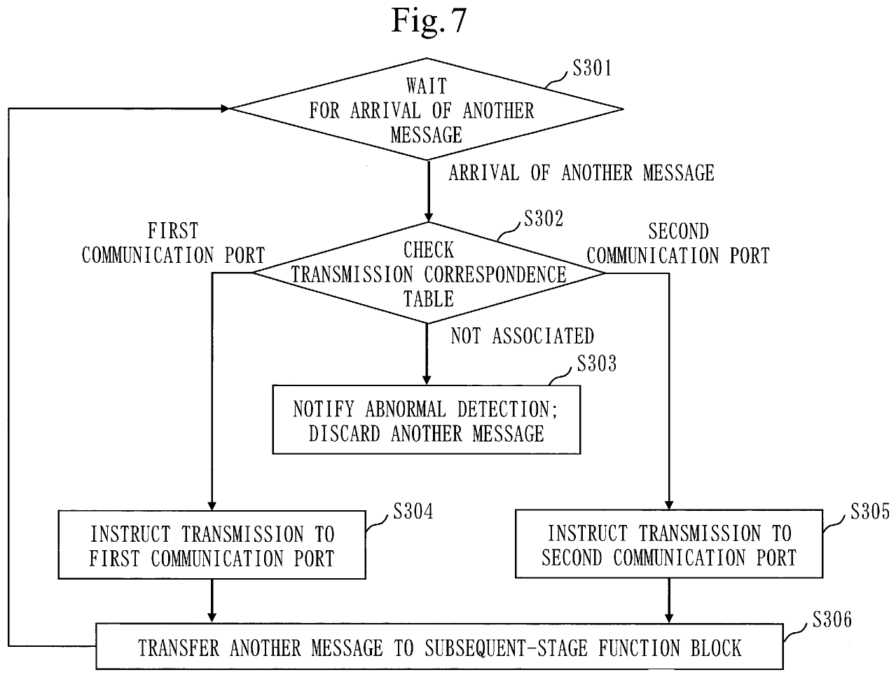

Operations of the path control unit 108 according to the present embodiment in transmission of another message will now be described with referring to FIG. 7. Assume that another message refers to a message that is neither a BMCA message nor a PTP message.

In step S301, the transmission selection unit 109 waits for arrival of another message from the synchronization control unit 107. Upon reception of another message, the transmission selection unit 109 proceeds to step S302. Another message contains domain information.

In step S302, the transmission selection unit 109 decides to which communication port to transmit another message, based on the transmission correspondence table 181 and domain information in another message.

If having decided in step S302 that a communication port to which to transmit another message is not associated, the transmission selection unit 109 notifies abnormal detection and discards another message (step S303). If having decided that the communication port to which to transmit another message is the first communication port, the transmission selection unit 109 outputs a transmission instruction for transmitting another message to the first communication port (step S304). If having decided that the communication port to which to transmit another message is the second communication port, the transmission selection unit 109 outputs a transmission instruction for transmitting another message to the second communication port (step S305). Then, in step S306, the transmission selection unit 109 transmits another message to the subsequent-stage filtering unit 103 together with the transmission instruction.

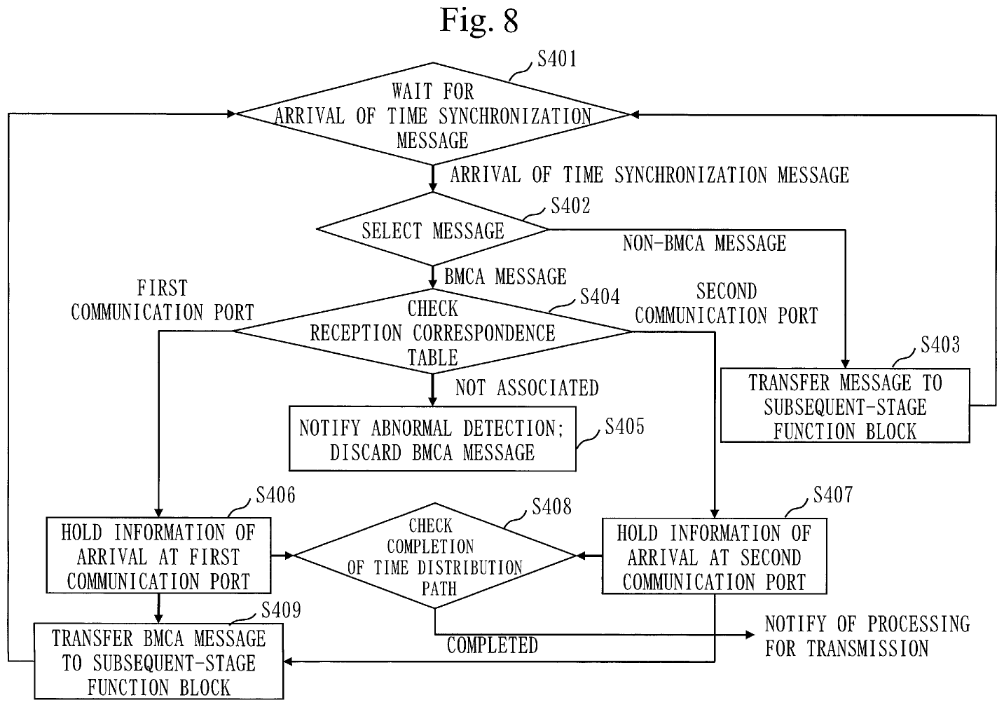

FIG. 8 describes operations of the path control unit 108 according to the present embodiment in reception of a message.

Upon reception of a frame, the filtering unit 103 identifies whether or not the frame is a time synchronization message. If the frame is a time synchronization message, the filtering unit 103 makes the time synchronization message to pass through even when the port is a closed port, and sends the time synchronization message to the path control unit 108. The filtering unit 103 is a configuration that forms a preceding stage of the path control unit 108 in reception.

In step S401, the message selection unit 110 waits for arrival of the time synchronization message from the filtering unit 103. Upon reception of the time synchronization message, the message selection unit 110 proceeds to step S402. The time synchronization message includes a BMCA message and a PTP message. The time synchronization message contains domain information and communication port information.

In step S402, the message selection unit 110 decides whether the time synchronization message is a BMCA message or a non-BMCA message. If the time synchronization message is a BMCA message, the processing proceeds to step S404. If the time synchronization message is a non-BMCA message, the processing proceeds to step S403.

In step S403, the time distribution message reception unit 111 transmits the non-BMCA message, that is, the PTP message, out of the time synchronization message to the synchronization control unit 107 which is a subsequent-stage function block.

In step S404, the message selection unit 110 decides the domain and the communication port of the BMCA message based on the reception correspondence table 182.

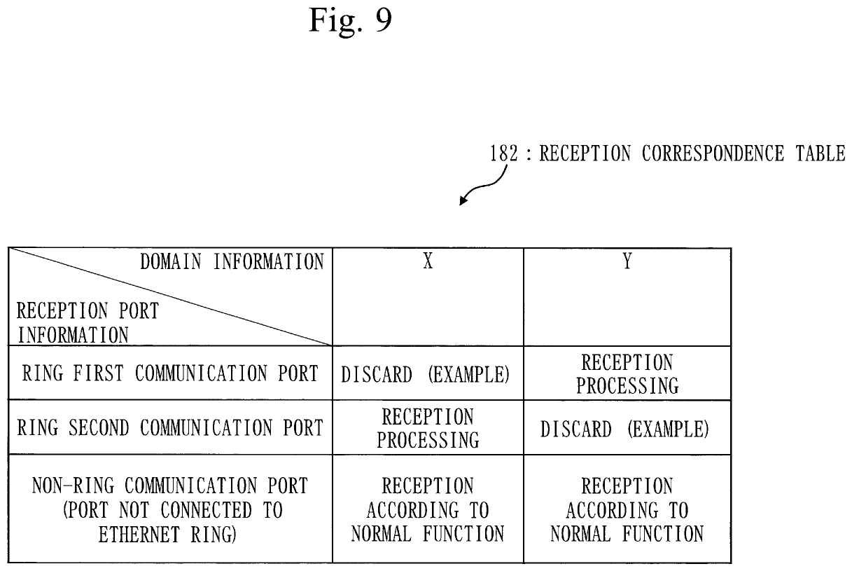

FIG. 9 is a diagram illustrating a configuration of the reception correspondence table 182 according to the present embodiment.

The reception correspondence table 182 contains domain information and reception port information. These contents are opposite to the contents of the transmission correspondence table 181.

When, for example, the reception port information in the BMCA message is the ring first communication port and the domain information in the BMCA message is Y, reception processing is carried out in response to the BMCA message. When, for example, the reception port information in the BMCA message is the second communication port and the domain information in the BMCA message is Y, the BMCA message will be discarded. When, for example, the reception port information in the BMCA message is a non-ring third communication port, the BMCA message will be received according to the normal function. That is, when the reception port information in the BMCA message is a non-ring third communication port and a port of the network device 100 is a closed port, the MBCA message will be discarded.

Note that the BMCA message is a target of check processing carried out using the reception correspondence table 182. If the message is other than a BMCA message, the check processing using the reception correspondence table 182 is unnecessary. If the reception correspondence table 182 indicates message reception by the non-ring third communication port, the message is transferred by a flow of from the ERP processing unit 102 to the synchronization control unit 107.

If having decided in step S404 that a communication port to which to transmit the BMCA message is not associated, the message selection unit 110 notifies abnormal detection and discards the BMCA message (step S405). If having decided that the communication port corresponding to the domain of the BMCA message is the first communication port, the message selection unit 110 outputs arrival information indicating that the BMCA message has arrived at the first communication port (step S406). If having decided that the communication port corresponding to the domain of the BMCA message is the second communication port, the message selection unit 110 outputs arrival information indicating that the BMCA message has arrived at the second communication port (step S407).

After step S406 or step S407, the message selection unit 110 performs completion checking on the time distribution path and notifies the transmission selection unit 109 of a checking result (step S408). Specifically, the checking result notified by the message selection unit 110 is used for completion decision, performed by the transmission selection unit 109, of the time distribution path in step S202.

In step S408, upon acquisition of the path generation message, that is, the BMCA message out of the time synchronization message, the path checking unit 112 checks whether or not a time distribution path is completed, based on domain information and a communication port via which the path completion message has been received. Then, the path checking unit 112 notifies the transmission selection unit 109 of a checking result. The path checking unit 112 checks whether or not a time distribution path is completed, using master update information including a number of times information is updated by the time master. This is specifically as follows.

If the path checking unit 112 is a time master, the path checking unit 112 checks StepsRemoved (and trace information) in the BMCA message received in both of the two communication ports, that is, the first communication port and the second communication port. If a value of StepsRemoved is the same in both of the two communication ports, the path checking unit 112 decides that a clockwise time distribution path and a counterclockwise distribution path that start at the time master are completed. The path checking unit 112 may utilize a status of completion or non-completion as information by which a network abnormality is detected.

In step S409, the message selection unit 110 transmits the BMCA message to the synchronization control unit 107 which is a subsequent-stage function block, together with arrival information.

As described above, in reception, a time synchronization message received from the communication port is classified under the BMCA messages and the other messages by the message selection unit 110. In the case of a BMCA message, the communication port via which the message has been received and domain information in the BMCA message are checked with using the reception correspondence table 182 indicating the domain and the communication port. If the checking result matches the reception correspondence table 182, the BMCA message is transferred to a subsequent-stage function block.

***Other Configurations***

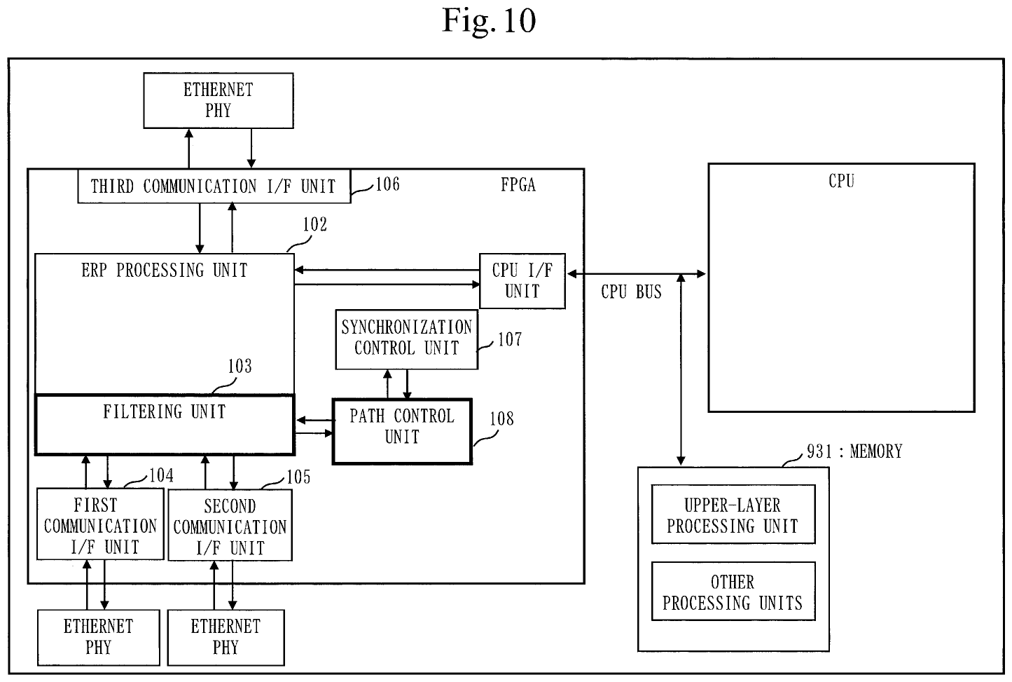

FIG. 10 is a diagram illustrating a modification of a hardware configuration of the network device 100 according to the present embodiment.

FIG. 10 illustrates a hardware configuration of an FPGA base. In FIG. 10, a synchronization control unit 107 and a path control unit 108 are packaged in an FPGA.

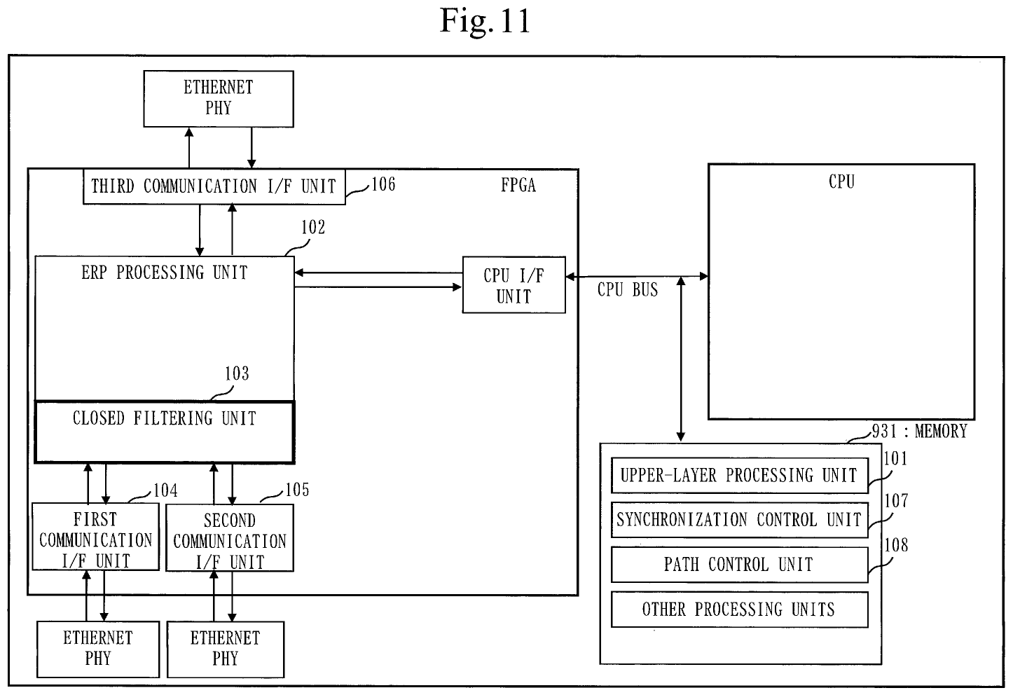

FIG. 11 illustrates another modification of the hardware configuration of the network device 100 according to the present embodiment.

FIG. 11 illustrates a hardware configuration of a CPU base. In FIG. 11, a synchronization control unit 107 and a path control unit 108 are packaged in a CPU.

Referring to FIG. 3, a case has been described where the functions of the individual units of the network device 100 are implemented by software. However, the functions of the individual units of the network device 100 nay be implemented by hardware such as an electronic circuit.

The electronic circuit is a dedicated electronic circuit that implements the functions of the network device 100.

The electronic circuit is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array.

The functions of the network device 100 may be implemented by one electronic circuit, or may be implemented by a plurality of electronic circuits through distribution.

Some of the functions of the network device 100 may be implemented by an electronic circuit, and the remaining functions may be implemented by software.

The processor and the electronic circuit are each called processing circuitry as well. That is, the upper-layer processing unit 101, the ERP processing unit 102, the first communication interface unit 104, the second communication interface unit 105, the third communication interface unit 106, the synchronization control unit 107, and the path control unit 108 which are the functions of the network device 100 are implemented by processing circuitry.

In the present embodiment, the network system using ERP control has been described. The present embodiment is not particularly limited to an ERP-control network system but may be applied to any network system that executes network control using a closed port.

### Description of Effect of Present Embodiment

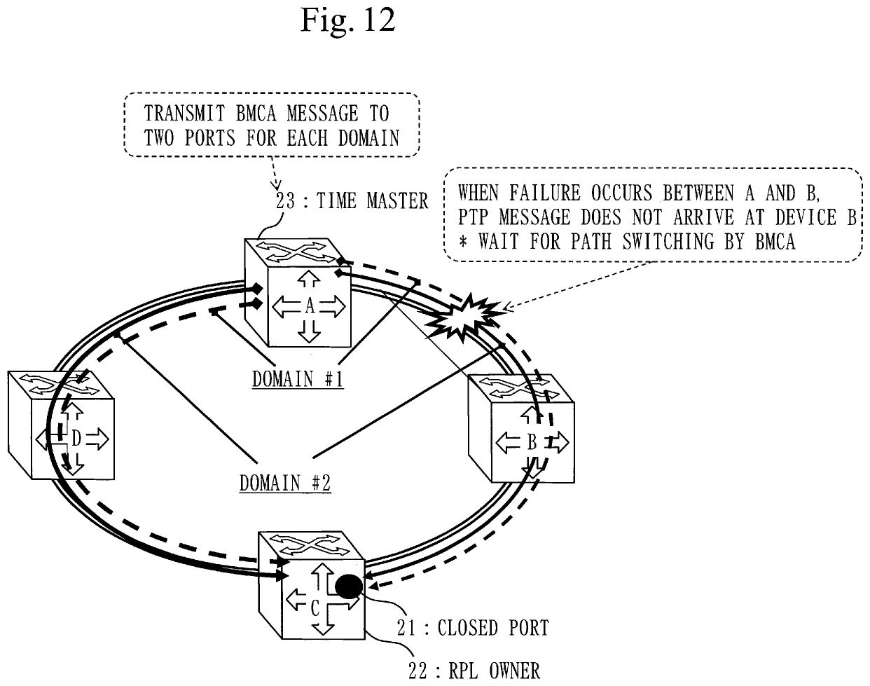

FIG. 12 is a diagram illustrating a comparative example of a time distribution path constituted by a dual-ring network that uses an ERP. In the network system of FIG. 12, when a failure occurs between a network device A and a network device B, a PTP message does not arrive at the network device B even though the time distribution path has been made redundant. In this manner, in the network system of FIG. 12, sometimes the PTP message does not arrive until route change of the time distribution path is completed by the BMCA.

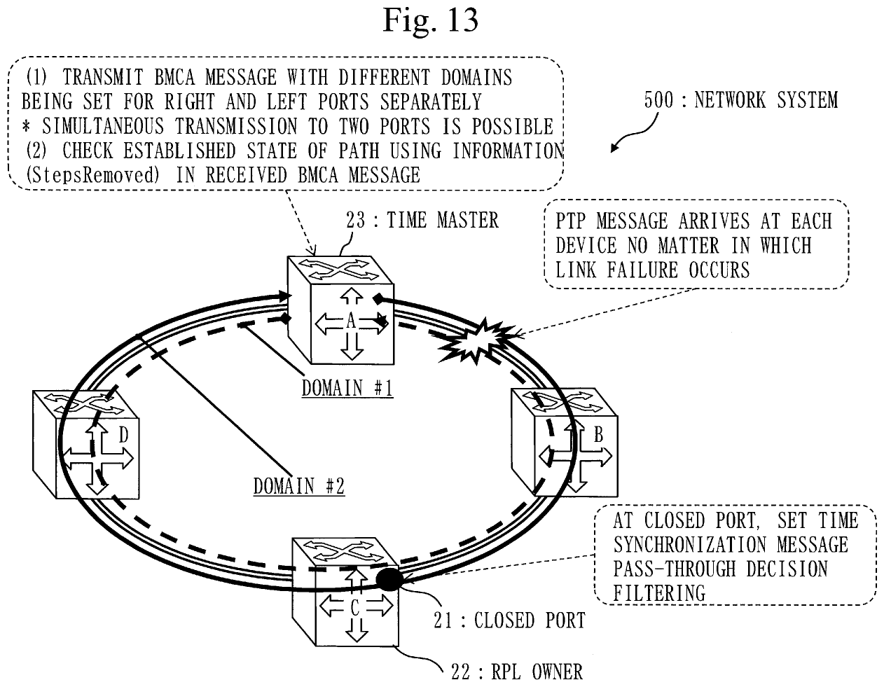

FIG. 13 is a diagram illustrating an example of time distribution paths constituted by the network system 500 according to the present embodiment. In the present embodiment, time distribution paths are constructed reliably along a clockwise ring and a counterclockwise ring. That is, the network device 100 according to the present embodiment can generate a clockwise time distribution path and a counterclockwise time distribution path which start at and terminate at a time master, so that time distribution paths intended by the device itself can be obtained. The network system 500 according to the present embodiment of FIG. 13 can endure a single failure no matter where the failure occurs, so that an effect of making redundant can be obtained. This is because in the case of a single failure, every network device can receive a PTP message reliably by one or the other of its two communication ports.

As described above, in the network system 500 according to the present embodiment, time distribution paths as illustrated in FIG. 13 can be formed. Furthermore, the network system 500 according to the present embodiment can utilize a time synchronization message to be used by time synchronization defined by IEEE 1588 without any change. Therefore, to implement the present embodiment, the functions of the present embodiment may be added to an existing network device. Hence, with the network system 500 according to the present embodiment, a development cost can be reduced.

As described above, in the network system 500 according to the present embodiment, when transmitting a time synchronization message coming from the existing synchronization control unit 107, it is selected to which communication port to transmit the time synchronization message by referring to the correspondence between the value of the domain and the communication port. Consequently, in the network system 500, a BMCA message is transmitted to a communication port of one ring in units of domains. Thus, in the network system 500, a BMCA message having information of the time master can generate a clockwise time distribution path and a counterclockwise time distribution path starting at a time master, passing through devices each having a closed port which are on the way, and finally terminating at a time master. Consequently, in an EPR-compliant dual-ring network, time information from the time master can be acquired via one or the other of the two time distribution paths, in the case of single failure occurrence, no matter where the single failure occurred, so that time synchronization can continue. Also, in the network system 500, it is possible to achieve this effect without changing the existing synchronization control unit 107 but by adding the function of the path control unit 108 and the function of the filtering unit 103.

As described above, in the network system 500 according to the present embodiment, the time master checks information of StepsRemoved in the BMCA message that has arrived. Then, the time master compares information from the right communication port and information from the left communication port. If the compared values are equal, the time master decides that desired time distribution paths are generated. As a result, the reliability can be improved.

### Embodiment 2

In the present embodiment, a difference from Embodiment 1 will mainly be described. The same configuration as in Embodiment 1 will be denoted by the same reference sign, and its description will sometimes be omitted.

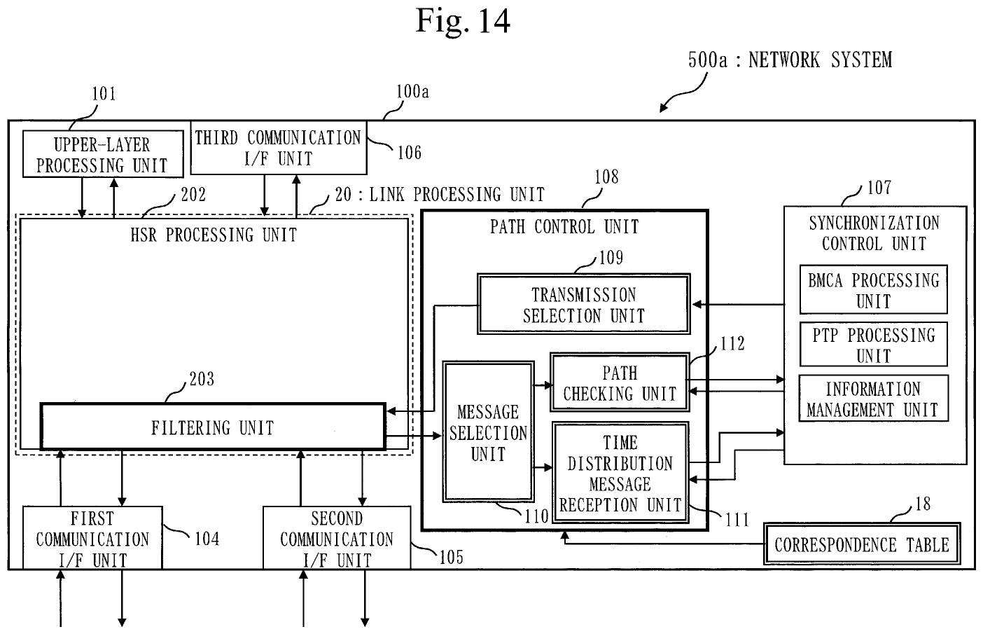

FIG. 14 is a diagram illustrating a functional configuration of a network device 100a according to the present embodiment.

The network device 100a is a network device arranged on a network system 500a that uses HSR control.

The network device 100a of FIG. 14 is provided with an HSR processing unit 202 in place of the ERP processing unit 102 of FIG. 2, as a link processing unit 20. The network device 100a is also provided with a filtering unit 203 in place of the filtering unit 103 of FIG. 2. The filtering unit 203 is also referred to as a broadcast reception discard/pass-through decision filtering unit.

The HSR processing unit 202 which is the link processing unit 20 has, as a frame discarding function, a frame selective discarding function of selectively discarding a frame when the frame is received. Upon reception of a time synchronization message out of the frame, the filtering unit 203 makes the time synchronization message to pass through regardless of the frame selective discarding function.

The HSR processing unit 202 executes a function of an Ethernet (registered trademark) switch (layer 2 switch) and HSR processing. The HSR processing unit 202 has an address learning table inside. The HSR processing unit 202 has a function of processing transfer to individual communication ports, a function of failure detection, a function of generating a control frame to be used for ERP, and a frame multiplexing/separation control function.

The frame multiplexing/separation control function is functionally split among a ring port output processing unit, an upper-layer output processing unit, and a non-ring port output processing unit.

The ring port output processing unit executes transmission arbitration of multiplexing frames inputted from a plurality of communication ports for one output communication port and deciding a frame to be outputted to an Ethernet (registered trademark) ring. The frames inputted from the plurality of communication ports include a frame on an Add traffic which has been transferred from an upper-layer processing unit 101 and a frame on a Transit traffic which has been transferred from a first communication interface unit 104 or a second communication interface unit 105. The upper-layer output processing unit executes transmission arbitration of outputting the frames to an upper-layer processing unit that multiplexes the frames on a Drop traffic which have been transferred from the first communication interface unit 104 or the second communication interface unit 105.

The HSR processing unit 202 is also in charge of controlling the ERP, being a network control protocol by a layer 2. In transmission, the HSR processing unit 202 performs broadcasting transmission to the first communication port and the second communication port which are the two ring ports. The HSR processing unit 202 has a function of deciding via which one of the two ring ports to receive or discard a frame on the reception side, and a frame forwarding function of deciding to which port (or the upper-layer processing unit) to transfer a frame received utilizing FDB.

The filtering unit 203 has a function of identifying whether to receive or discard a broadcast frame, and making the frame to pass through when the frame is a time synchronization message, even if the frame is to be discarded.

Functions of the other function elements are the same as in Embodiment 1 except that the network system switches from ERP control to HSR control. For example, the reception processing unit of the first communication interface unit 104 extracts information of an HSR tag in addition to information for searching FDB from the received frame.

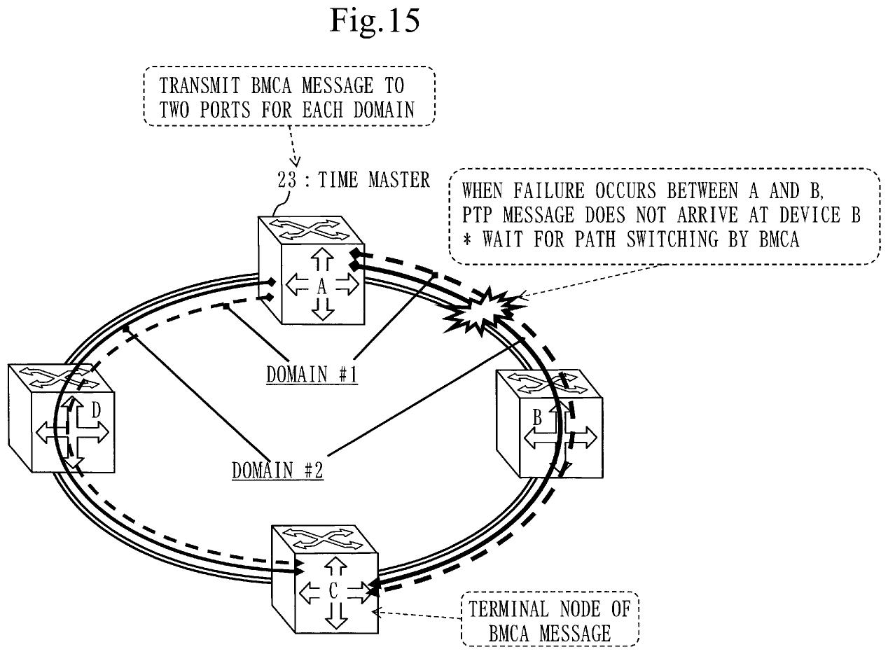

FIG. 15 is a diagram illustrating an example of a time distribution path constituted on a dual-ring network using HSR. When a failure occurs, it is possible that a PTP message does not arrive depending on a failure location even though the time distribution path has been made redundant. In the dual-ring network of FIG. 15, a PTP message does not arrive until route change of the time distribution path is completed by BMCA.

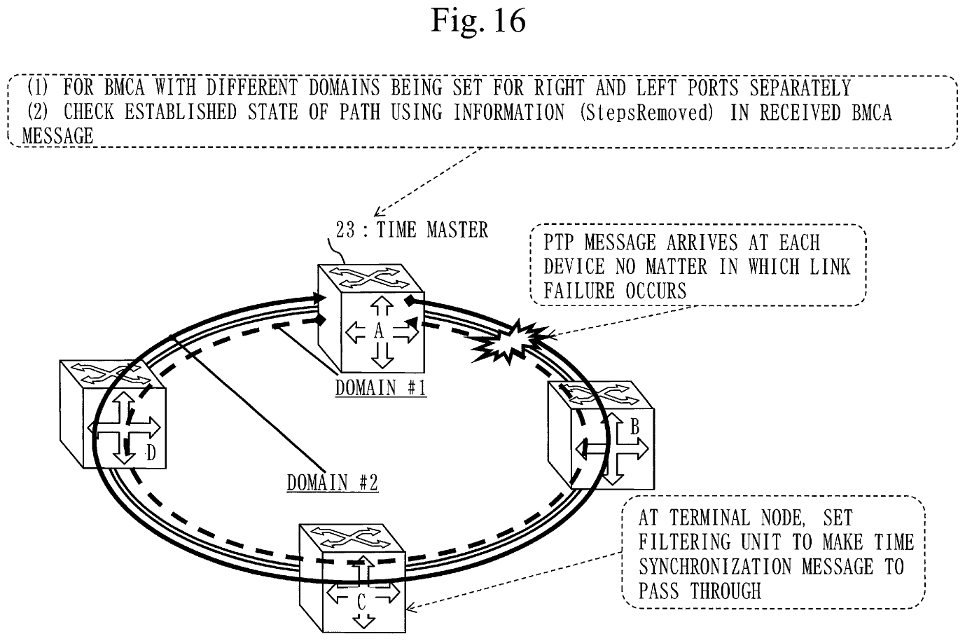

FIG. 16 is a diagram illustrating an example of time distribution paths constituted on a dual-ring network using HSR according to the present embodiment. As illustrated in FIG. 16, time distribution paths are constructed reliably along a clockwise ring and a counterclockwise ring. The dual-ring network of FIG. 16 that uses HSR can endure a single failure no matter where the failure occurs, so that an effect of making redundant can be obtained. This is because in the case of a single failure, every network device can receive a PTP message reliably by one or the other of its two communication ports.

In this manner, with the network device 100a according to the present embodiment, in an HSR-compliant dual-ring network as well, time information from the time master can be acquired via one or the other of the two time distribution paths even in the case of single failure occurrence, no matter where the single failure occurred, so that time synchronization can continue. Also, in the network device 100a according to the present embodiment, it is possible to achieve this effect without changing an existing synchronization control unit but by adding the function of the path control unit and the function of the filtering unit.

In the present embodiment, a network system using HSR control has been described. The present invention is not particularly limited to an HSR-control network system but may be applied to any network system that executes network control similar to that of an HSR-control network system.

### Embodiment 3

In the present embodiment, a difference from Embodiment 1 will mainly be described. The same configuration as in Embodiment 1 will be denoted by the same reference sign, and its description will sometimes be omitted.

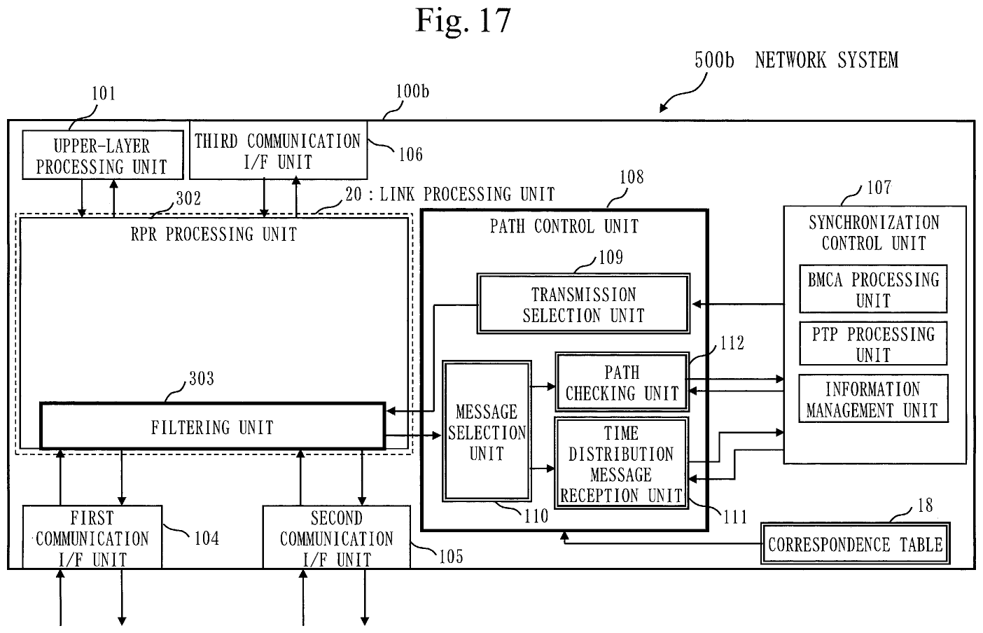

FIG. 17 is a diagram illustrating a functional configuration diagram of a network device 100b according to the present embodiment.

The network device 100b is a network device arranged on a network system 500b that uses RPR control.

The network device 100b of FIG. 17 is provided with an RPR processing unit 302 in place of the ERP processing unit 102 of FIG. 2, as a link processing unit 20. The network device 100b is also provided with a filtering unit 303 in place of the filtering unit 103 of FIG. 2. The filtering unit 303 is also referred to as a frame termination/pass-through decision filtering unit.

The RPR processing unit 302 which is the link processing unit 20 has, as a frame discarding function, a frame terminating function according to which a network device 100b other than a time master, among a plurality of network devices 100b is provided with a frame terminating device that terminates a frame.

Upon reception of a time synchronization message out of the frame, the filtering unit 303 makes the time synchronization message to pass through regardless of the frame terminating function.

The RPR processing unit 302 executes a function of an Ethernet (registered trademark) switch, that is, a layer 2 switch, and RPR processing. The RPR processing unit 302 is functionally split among a ring port output processing unit, an upper-layer output processing unit, and a non-ring port output processing unit.

The ring port output processing unit executes transmission arbitration of multiplexing frames inputted from a plurality of communication ports for one output communication port and deciding a frame to be outputted to an Ethernet (registered trademark) ring. The frames inputted from the plurality of communication ports include a frame on an Add traffic which has been transferred from an upper-layer processing unit 101 and a frame on a Transit traffic which has been transferred from a first communication interface unit 104 or a second communication interface unit 105. The upper-layer output processing unit executes transmission arbitration of outputting the frames to an upper-layer processing unit that multiplexes the frames on a Drop traffic which have been transferred from the first communication interface unit 104 or the second communication interface unit 105.

The RPR processing unit 302 is also in charge of controlling the RPR, being a network control protocol by a layer 2. The RPR processing unit 302 has the following functions for RPR control.

(1) A protection function which is a function for generating, adding, and deleting an RPR header, for detecting a failure, and for bypassing a route where the failure occurs. (2) A Quality of Service (QoS) function which is a function for selectively outputting a high-priority traffic preferentially and for guaranteeing a necessary band. (3) A fairness control function which is a function of avoiding a band on the network when the band gets pressure from an upstream communication device, and sharing a non-used band among individual communication devices. (4) A topology discovery function which is a function of grasping a layout of communication devices arranged on the network and registering the layout with a table (topology information table) held by the communication devices. (5) A frame forwarding function of judging to which port to transfer a frame received utilizing the above-mentioned topology information table (or judging whether to transfer the frame to the upper-layer processing unit). (6) A function of generating a control frame to be utilized by RPR that is necessary for the above functions and transmitting the generated control frame to a ring port (the first communication interface unit 104 or the second communication interface unit 105).

The filtering unit 303 identifies whether to receive and terminate or to receive and discard a frame that has been designated to be terminated or not when the frame is transmitted. The filtering unit 303 has a function of making the frame to pass through when the frame is a time synchronization message, even if the frame is to be terminated.

Functions of the other function elements are the same as in Embodiment 1 except that the network system switches from ERP control to RPR control.

An effect of the network that adopts RPR is the same as in FIGS. 15 and 16, and the same effect as in Embodiment 2 can be obtained.

In this manner, with the network device 100b according to the present embodiment, in an RPR-compliant dual-ring network as well, time information from the time master can be acquired via one or the other of the two time distribution paths even in the case of single failure occurrence, no matter where the single failure occurred, so that time synchronization can continue. Also, in the network device 100b according to the present embodiment, it is possible to achieve this effect without changing an existing synchronization control unit 107 but by adding a function of a path control unit 108 and a function of the frame terminating filtering unit 303.

In the present embodiment, a network system using RPR control has been described. The present invention is not particularly limited to an RPR-control network system but may be applied to any network system that executes network control similar to that of an RPR-control network system.

### Embodiment 4

In the present embodiment, a difference from Embodiment 1 will mainly be described. The same configuration as in Embodiment 1 will be denoted by the same reference sign, and its description will sometimes be omitted.

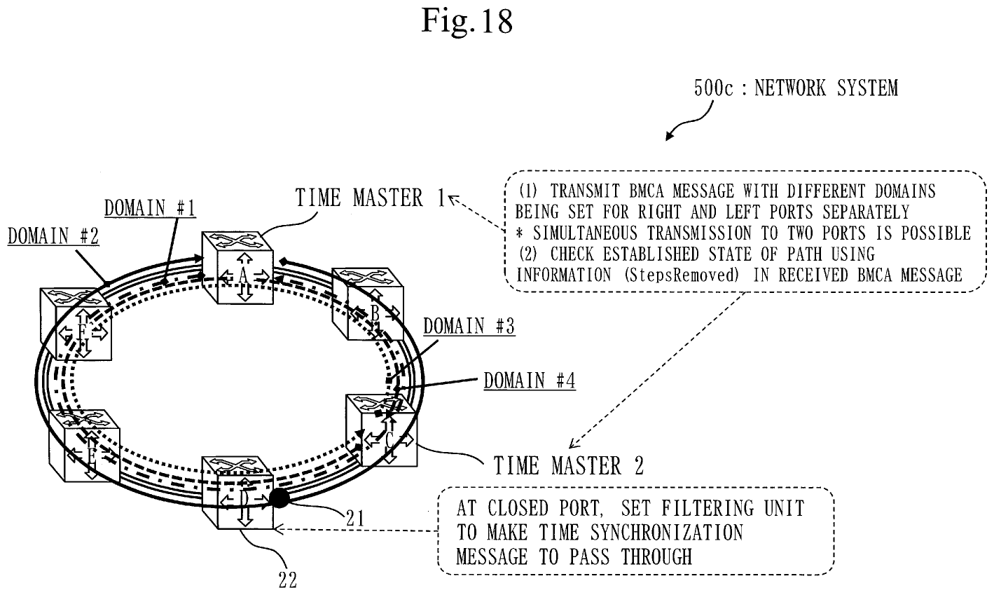

FIG. 18 is a diagram illustrating a configuration of a network system 500c according to the present embodiment. A functional configuration and operations of each network device 100 in the network system 500c are the same as those in Embodiment 1.

The network system 500c according to the present embodiment is provided with a plurality of time masters. A path control unit 108 generates a counterclockwise time distribution path and a counterclockwise time distribution path for each of the plurality of time masters.

The network system 500c of FIG. 18 illustrates time distribution paths constituted on a dual-ring network using ERP. The network system 500c has a redundant configuration including two time masters. In the configuration of the network system 500c as well, two domains constituting the clockwise and counterclockwise time distribution paths are set for each time master. In FIG. 18, a domain #1 and a domain #2 are set for a time master 1. A domain #3 and a domain #4 are set for a time master 2. In the network device 100, a path control unit is extended such that it operates with four domains, thereby providing the same effect as in Embodiment 1.

FIG. 18 illustrates an example in which two time masters are applied to a network system using ERP control. This structure can also be applied to the HSR-control or RPR-control network system described above. That is, this structure can be applied to two time masters by using a broadcast reception discard/pass-through decision filtering unit or a frame termination/pass-through decision filtering unit, and the path control unit 108.

### Embodiment 5

In the present embodiment, a difference from Embodiment 1 will mainly be described. The same configuration as in Embodiment 1 will be denoted by the same reference sign, and its description will sometimes be omitted.

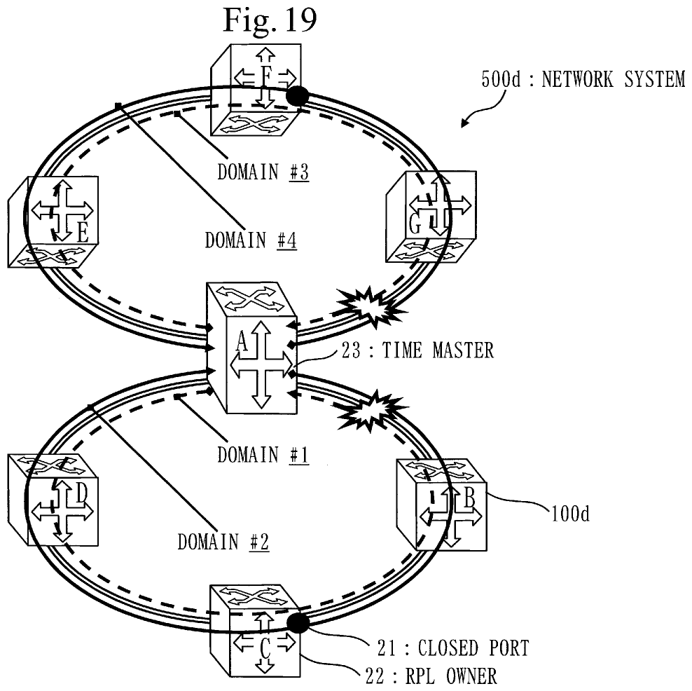

FIG. 19 is a diagram illustrating a configuration of a network system 500d according to the present embodiment.

The network system 500d according to the present embodiment is provided with a plurality of ring-type network systems sharing a time master 23. Path control units 108 and 108d generate time distribution paths clockwise and counterclockwise of the time master 23 for each of the plurality of ring-type network systems.

The network system 500d of FIG. 19 illustrates time distribution paths constituted on a dual-ring network using ERP. The network system 500d has a configuration including a plurality of rings. In the configuration of the network system 500d as well, two domains constituting the clockwise and counterclockwise time distribution paths are set for the time master 23 in each ring. In the network device 100d, the path control units 108 and 108d are extended such that they operate with four domains, thereby providing the same effect as in Embodiment 1.

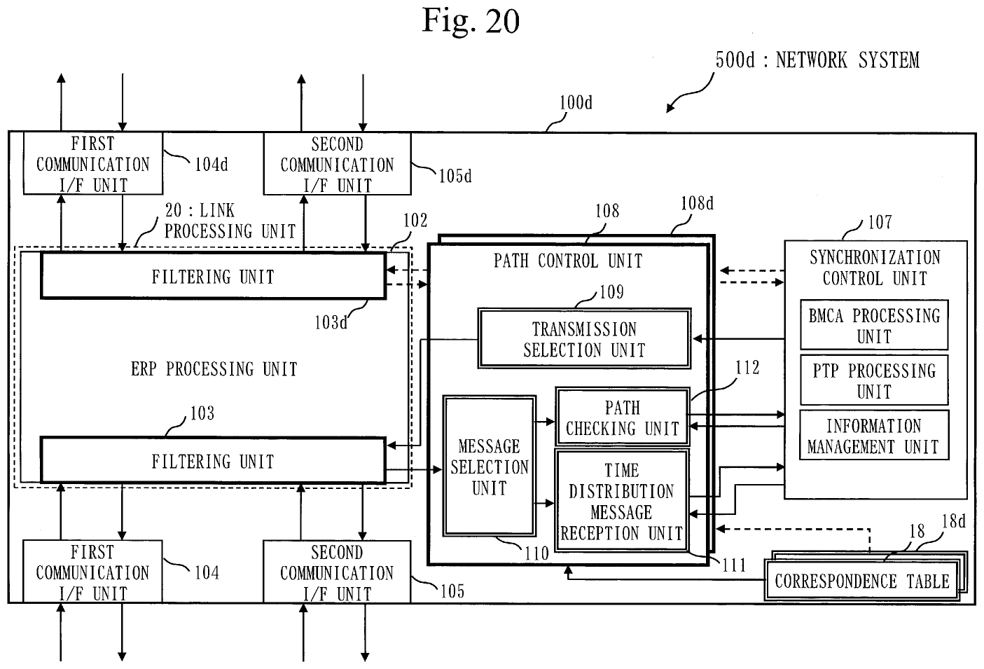

FIG. 20 is a diagram illustrating a functional configuration of a network device 100d according to the present embodiment. An upper-layer processing unit 101 and a third communication interface unit 106 are not illustrated in FIG. 20.

In order to realize the configuration of FIG. 19, the network device 100d is provided with a filtering unit 103 or 103d, a first communication interface unit 104 or 104d, a second communication interface unit 105 or 105d, and a path control unit 108 or 108d for each ring.

FIG. 19 illustrates an example in which a plurality of rings are applied to a network system using ERP control. This structure can also be applied to the HSR-control network system or RPR-control network system described above. That is, this structure can be applied to a plurality of rings by using a broadcast reception discard/pass-through decision filtering unit 203 or a frame termination/pass-through decision filtering unit 303, and a path control unit 108.

In Embodiment 1, each unit of the network device is described as an independent functional element. However, the configuration of the network device need not be limited to the configuration as in the embodiments described above. The functional elements of the network device may form any configuration as far as the functions described in the embodiments described above can be implemented.

Of Embodiments 1 to 5, a plurality of portions may be practiced in combination. Alternatively, of these embodiments, only one portion may be practiced. Also, these embodiments may be practiced entirely or partly in any combination. The embodiments described above are essentially preferable exemplifications and are not intended to limit the scope of the present invention, the scope of an applied product of the present invention, and a scope of application of the present invention. Various changes can be made to the embodiments described above as necessary.

### REFERENCE SIGNS LIST

18: correspondence table; 20: link processing unit; 21: closed port; 22: RPL owner; 23: time master; 100, 100a, 100b, 100d: network device; 101: upper-layer processing unit; 102: ERP processing unit; 103, 203, 303: filtering unit; 104: first communication interface unit; 105: second communication interface unit; 106: third communication interface unit; 107: synchronization control unit; 108: path control unit; 109: transmission selection unit; 110: message selection unit; 111: time distribution message reception unit; 112: path checking unit; 181: transmission correspondence table; 182: reception correspondence table; 202: HSR processing unit; 302: RPR processing unit; 500, 500a, 500b, 500c, 500d: network system; 910: processor; 921, 922, 923: PHY chip; 931: memory.

1. A network device included in a ring-type network system which comprises a plurality of network devices to transmit and receive a frame and which selects a time master serving as a time criterion, from among the plurality of network devices, the network device comprising:
processing circuitry
to generate a link for communicating the frame, the processing circuitry having a frame discarding function of discarding the frame in order to avoid a broadcast storm,
to generate a time distribution path starting at and terminating at the time master, clockwise and counterclockwise of the time master, the time distribution path communicating a time synchronization message out of the frame, the time synchronization message being used for time synchronization of the plurality of network devices, and
to make, upon acquisition of the time synchronization message, the time synchronization message to pass through regardless of the frame discarding function.

2. The network device according to claim 1,
wherein the processing circuitry, upon acquisition of a time distribution message containing the time criterion, out of the time synchronization message, decides whether or not the time distribution path is completed, and if having decided that the time distribution path is completed, sends the time distribution message.

3. The network device according to claim 2, comprising:
a first communication port;
a second communication port; and
a correspondence table in which each of the first communication port and the second communication port is associated with each of a domain corresponding to a clockwise time distribution path and a domain corresponding to a counterclockwise time distribution path,
wherein the processing circuitry sends the time synchronization message to a communication port corresponding to a domain which the time synchronization message belongs to, based on the correspondence table.

4. The network device according to claim 3,
wherein the processing circuitry
has, as the frame discarding function, a port closing function of closing a port when the frame is received, and
upon reception of the time synchronization message out of the frame, makes the time synchronization message to pass through regardless of the port closing function.

5. The network device according to claim 3,
wherein the processing circuitry
has, as the frame discarding function, a frame selective discarding function of selectively discarding the frame when the frame is received, and
upon reception of the time synchronization message out of the frame, makes the time synchronization message to pass through regardless of the frame selective discarding function.

6. The network device according to claim 3,
wherein the processing circuitry
has, as the frame discarding function, a frame terminating function according to which a network device other than the time master, among the plurality of network devices is provided with a frame terminating device that terminates the frame, and
upon reception of the time synchronization message out of the frame, makes the time synchronization message to pass through regardless of the frame terminating function.

7. The network device according to claim 2,
wherein the processing circuitry
upon acquisition of a path generation message for generating the time distribution path out of the time synchronization message, checks whether or not the time distribution path is completed, based on domain information and a communication port via which the path completion message has been received, and
decides whether or not the time distribution path is completed, using a checking result.

8. The network device according to claim 7,
wherein the processing circuitry checks whether or not the time distribution path is completed, using master update information including a number of times information is updated by the time master.

9. A ring-type network system which comprises a plurality of network devices to transmit and receive a frame and which selects a time master serving as a time criterion from among the plurality of network devices, the network system comprising:
processing circuitry
to generate a link for communicating the frame, the processing circuitry having a frame discarding function of discarding the frame in order to avoid a broadcast storm,
to generate a time distribution path starting at and terminating at the time master clockwise and counterclockwise of the time master, and communicating a time synchronization message out of the frame, the synchronization message being used for time synchronization of the plurality of network devices, and
to make, upon acquisition of the time synchronization message, the time synchronization message to pass through regardless of the frame discarding function.

10. The network system according to claim 9, wherein the time master terminates the time synchronization message.

11. The network system according to claim 9,
wherein the network system comprises a plurality of time masters, and
wherein the processing circuitry generates the time distribution path clockwise and counterclockwise for each of the plurality of time masters.

12. The network system according to claim 9,
wherein the network system comprises a plurality of ring-type network systems which share the time master, and
wherein the processing circuitry generates the time distribution path clockwise and counterclockwise of the time master for each of the plurality of ring-type network systems.

13. A network method of a network device included in a ring-type network system which comprises a plurality of network devices to transmit and receive a frame and which selects a time master serving as a time criterion, from among the plurality of network devices, the network method comprising
generating a link for communicating the frame, the network method having a frame discarding function of discarding the frame in order to avoid a broadcast storm,
generating a time distribution path starting at and terminating at the time master, clockwise and counterclockwise of the time master, the time distribution path communicating a time synchronization message out of the frame, the time synchronization message being used for time synchronization of the plurality of network devices, and
upon acquisition of the time synchronization message, making the time synchronization message to pass through regardless of the frame discarding function.

14. A non-transitory computer readable medium containing a network program of a network device included in a ring-type network system which comprises a plurality of network devices to transmit and receive a frame and which selects a time master serving as a time criterion, from among the plurality of network devices, the network program causing the network device, being a computer, to execute
a link process of generating a link for communicating the frame, the link process having a frame discarding function of discarding the frame in order to avoid a broadcast storm,
a path control process of generating a time distribution path starting at and terminating at the time master, clockwise and counterclockwise of the time master, the time distribution path communicating a time synchronization message out of the frame, the time synchronization message being used for time synchronization of the plurality of network devices, and
a filtering process of, upon acquisition of the time synchronization message, making the time synchronization message to pass through regardless of the frame discarding function.
